(19) United States
(12) Patent Application Publication
(10) Pub. No.: US 2011/0272608 A1
(43) Pub. Date: Nov. 10, 2011

(54) DYNAMIC TRANSDUCER FOR CONTROLLING AIR ON DEMAND SYSTEMS

(76) Inventors: IULIUS VIVANT DUTU, BOCA RATON, FL (US); ROBERT MANUEL CARMICHAEL, FORT LAUDERDALE, FL (US)

(21) Appl. No.: 13/024,304

(22) Filed: Feb. 9, 2011

Related U.S. Application Data
(60) Provisional application No. 61/303,279, filed on Feb. 10, 2010.

(51) Int. Cl. F16K 31/08

(52) U.S. Cl. 251/65

(57) ABSTRACT

A dynamic transducer for use in a water surface supplied breathing system used by one or more divers underwater. The dynamic transducer in connection with a pressure switch allows the breathing system to not constantly run at all times, and therefore helps to conserve the battery life or the amount of combustible, since the motor of the breathing system is basically stalled at startup and at other times when there is sufficient amount of stored air. A controller can monitor the output pressure and the volume of air of the compressor assembly and can adjust the speed of the power propulsion to keep the right pressure available to each diver's mouthpiece based on the air demands of the user(s).

This application claims the benefit of and priority to U.S. Provisional Patent Application Ser. No. 61/303,279, filed Feb. 10, 2010, which application is incorporated by reference in its entirety.

### 1. FIELD OF THE INVENTION

The present invention relates generally to apparatuses for underwater breathing by a user, and specifically to a breathing apparatus which includes a controller and compressor located at surface for providing air on demand to the underwater diver and which permits the control of the speed of compressor based on the pressure and air volume provided by the compressor and the air used by the one or more divers using the breathing apparatus.

### 2. BACKGROUNG OF THE INVENTION

Surface located breathing apparatuses which provide air to underwater divers through a connected hose have been in existence for many years. These breathing apparatuses typically use an electric motor requiring a battery or electric engine requiring fuel. Therefore, the breathing apparatus has a relatively short time period before the battery is all used up or the engine requires more fuel. The present invention is directed to extending the time period between battery replacement or fuel replenishment through the incorporation and use of novel dynamic transducer as part of breathing apparatus technology.

### SUMMARY OF THE INVENTION

In a preferred embodiment, the present invention can provide a surface located (i.e. floating on the water surface, etc.) breathing apparatus to provide air to underwater users through one or more hose connections. The breathing apparatus can include an electric motor or engine, coupled to a compressor means for compressing the ambient air, and a controller in connection with the motor (engine) to control the function of the compressor. A mouth piece is coupled to the stored air within the hoses produced by the compressor for use by the underwater diver using the breathing apparatus. Multiple divers can be underwater and connected to the breathing apparatus at the same time, with each diver having his or her own mouthpiece and associated air hose line. The system further contains a power source means for providing power to the compressor means, and to a control circuit means for controlling some of the various functions of the present invention.

In various embodiments, the system can have a compressor powered by an electric motor, gas or diesel engine (all collectively referred to as “power propulsion”), a controller in connection with the power propulsion. The compressor can produce breathing air at a variable spin of the power propulsion. Through the preferred use of a dynamic sensor and pressure switch, the system does not constantly run at all times, and therefore helps to conserve the battery life or the amount of combustible, since the motor is basically stalled at startup and at other times when there is sufficient amount of stored air. The controller can monitor the output pressure and the volume of air (cubic feet per minute—CFM) of the compressor assembly and can adjust the speed of the power propulsion to keep the right pressure available to the mouthpiece based on the air demands of the user(s).

Other benefits of the invention include, but are not limited to, the control of the speed (spinning) of the motor (compressor) to a variable rate, based on the user's needs for more air, conserving the life of the battery or the amount of combustible.

### BRIEF DESCRIPTION OF THE DRAWINGS

FIG. 1 consists of several drawings of the magnetic sensor with Hall Effect in accordance with the present invention;

FIG. 2 is a block diagram of an underwater breathing apparatus incorporating the magnetic sensor of FIG. 1;

FIG. 3 is a graph illustrating certain design characteristics of the underwater breathing apparatus of FIG. 2; and

FIG. 4 is a perspective view of the magnetic sensor with Hall Effect in accordance with the present invention.

### DETAILED DESCRIPTION OF THE INVENTION

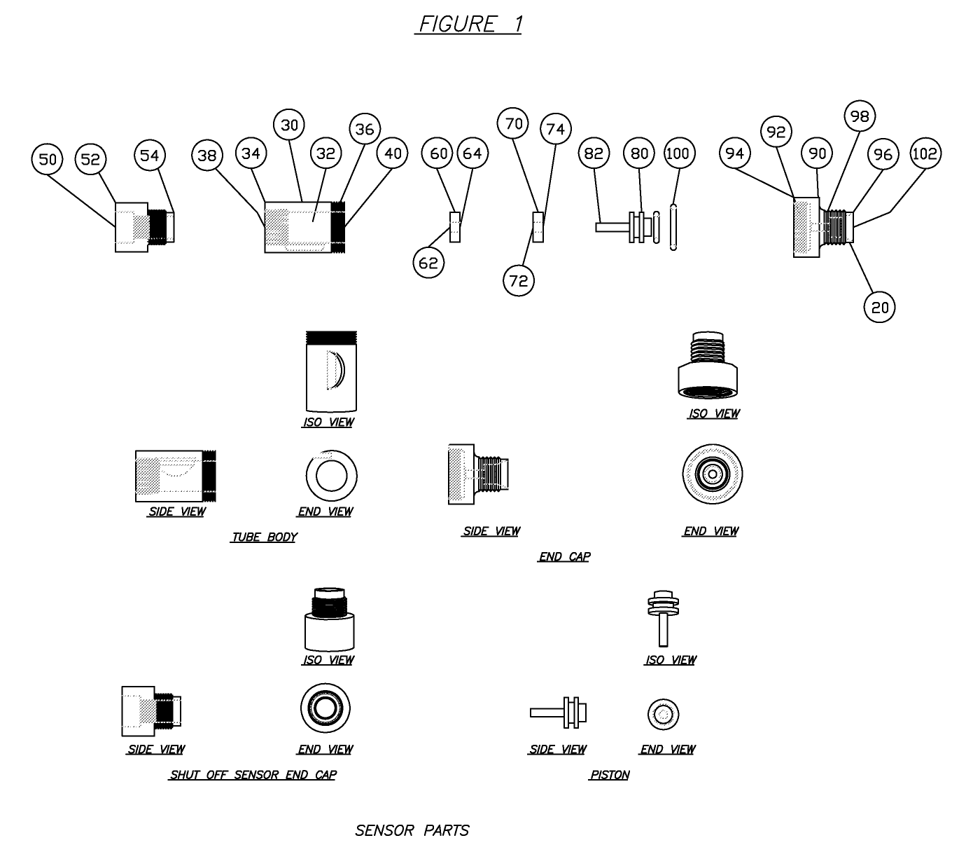

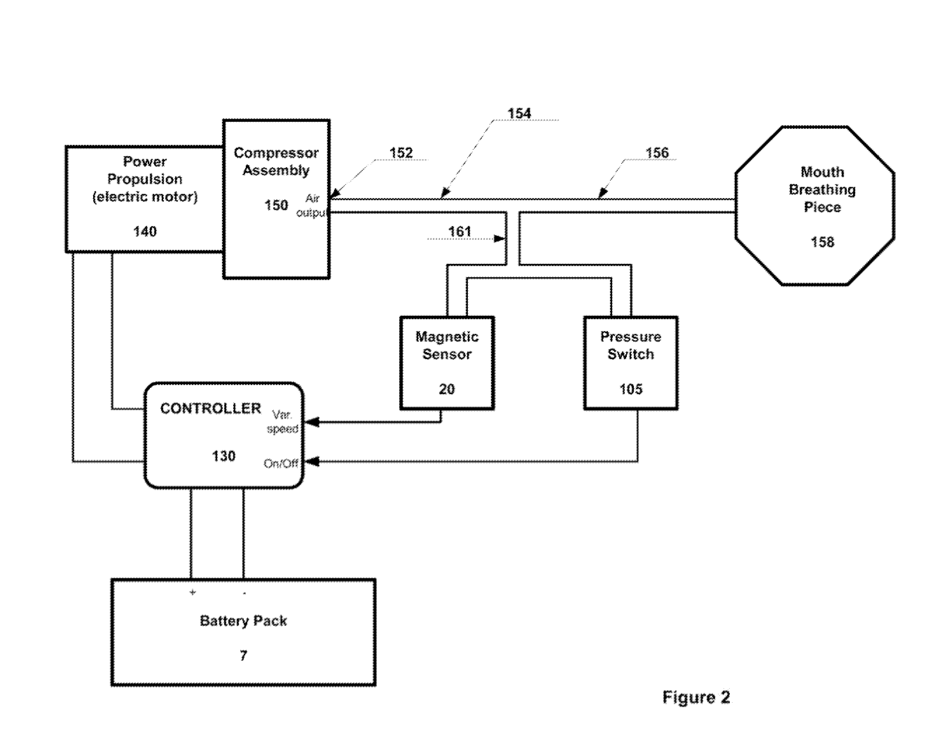

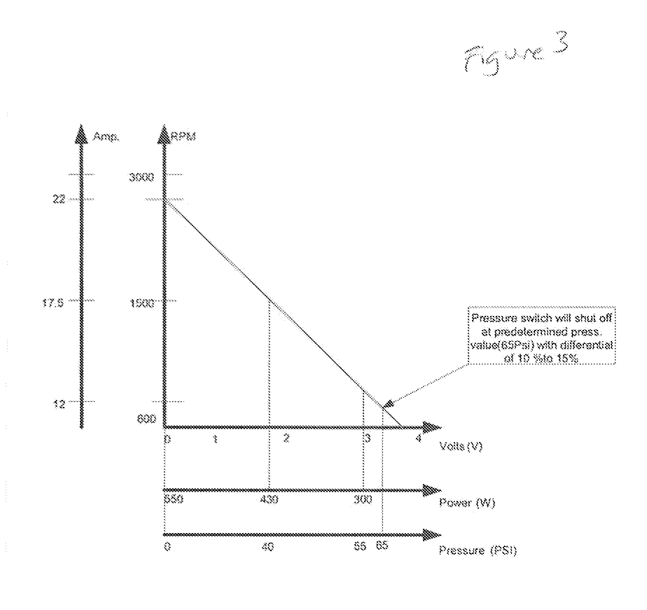

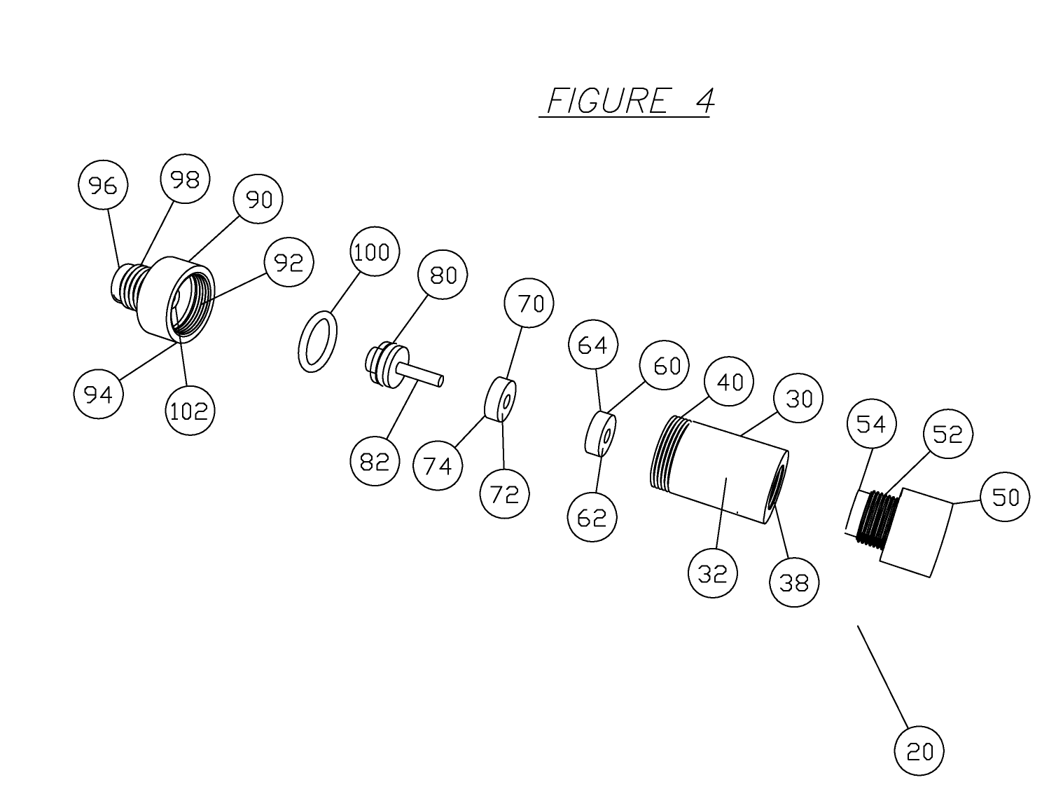

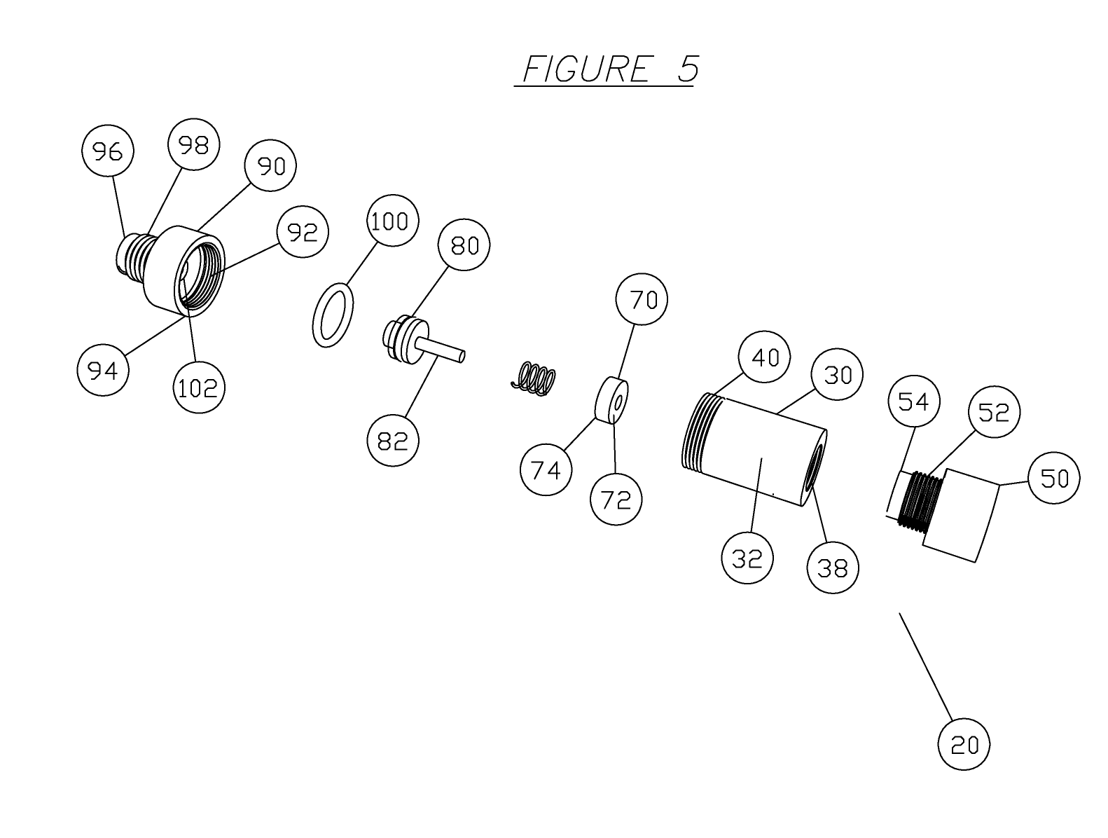

As seen in FIG. 1, the variable speed transducer of the present invention is shown in several views and in a preferred embodiment can be and generally designated as variable dynamic sensor 20. Preferably, sensor 20 can be a variable speed Hall Effect magnetic sensor, though such is not considered limiting. The use of a transducer or sensor provides a device that converts one type of energy into another form of energy. With the present invention the transducer allows for the conversion of pressure to electricity, preferably through the use of a magnetic field and Hall Effect described in more detail below.

Sensor 20 can include a housing or cylinder 30 having an internal passageway 32 therethrough extending from a first side 34 to a second side 36. Though a cylinder shape for housing 30 is preferred, it is not considered limiting and other shapes for the housing can be used and are considered within the scope of the invention. The end of passageway 32 associated with first side 34 can be preferably provided internal threads 38 and the external surface of cylinder 30 adjacent second 36 can be preferably provided with external threads 40.

A first end cap 50 having external threads 52 is secured at first side 34 of cylinder 30 by the mating of external threads 52 with internal threads 38 located within passageway 32. Other connection mechanisms for securing first end cap 50 to cylinder 30 can be used and are considered within the scope of the invention. End 54 of first end cap 50, which is disposed within passageway 32 when end cap 50 is secured to cylinder 30, acts as a stop member for a first magnet 60 that is disposed within passageway 32, whose purpose will be discussed below. First magnet 60 has a first side 62 having a first polarity (either + or −) and a second side 64 having an opposite polarity to the polarity of first side 62. A second magnet 70 is also disposed within passageway 32 and has a first side 72 having a first polarity and a second side 74 having opposite polarity to the polarity of first side 72. As a non-limiting example, the polarity of first side 62 of magnet 60 and the polarity of first side 72 of magnet 70 can be the same and the polarity of second side 64 of magnet 60 and the polarity of second side 74 of magnet 70 can be the same.

Where first side 62 of magnet 60 abuts end cap 50, then magnet 70 is positioned within passageway 32 such that second side 74 of magnet 70 is closest to magnet 60. Where second side 64 of magnet 60 abuts end cap 50, then magnet 70 is positioned within passageway 32 such that first side 72 of magnet 70 is closest to magnet 60. In either configuration the polarity of the sides of magnet 60 and 70 closest to each other are the same, such that magnets 60 and 70 are not attracted to each other and naturally repel each other. The repelling force of magnet 70 towards magnet 60 in conjunction with the fixed position of end 54 of first end cap 50 causes magnet 60 to preferably remain in a fixed position abutting end 54 virtually at all times during operation.

A piston or plunger or other movable member (collectively referred to as “piston 80”) is at least partially positioned and movable within passageway 32 for moving magnet 70 within passageway 32 as will be discussed in detail below. Piston 80 has a rod 82 or other contact member which contacts one of the sides of magnet 70. This contact between rod 82 and magnet 70 preferably remains virtually at all times during operation in view of magnet 60 and magnet 70 naturally repelling each other as discussed above.

A second end cap 90 having internal threads 92 at a first end 94 is secured to second side 46 of cylinder 30 by the mating of external threads 40 of cylinder 30 with the internal threads 92 of second end cap 90. The opposite end 96 of second end cap 90 is provided with external threads 98 for mating with a hose line (not shown) or any other conduit used for transporting air from a compressor, which will be discussed in more detail below. An o-ring 100 or other sealing device (i.e. gasket, etc.) can be disposed within second end cap to help prevent leakage of air. A passageway 102 is provided within second end cap 90 from first end 94 to second end 96 to permit air traveling through the hose attached to second end 96 to enter second end cap and contact piston 80, the purpose of which will be discussed in more detail below.

A cutout can be provided in the surface of cylinder 30, for receipt of a magnetic sensing element, preferably in the form of an integrated chip though such is not considered limiting, which senses the movement of magnet 70 within passageway 32. A pressure switch 105 can be provided and is in communication with hose line 161 that is secured to second end 96 of second end cap 90 and is in communication with a controller 130 used to control the operation of a power propulsion device (i.e. electric motor, etc.) 140 of a compressor assembly 150. Pressure switch 105 serves as an on/off switch for controller 130 and magnetic sensor 20 serves as a speed control which determines how fast to run power propulsion 140/compression assembly 150 when pressure switch 105 is closed, which causes controller 130 to be “on”.

Compressor assembly 150 for generating breathable air has an outlet 152 having an air hose line 154 (or other conduit) connected thereto. The single inlet of a splitting manifold, such as, but not limited to, a “T” or “Y” can be connected the opposite end of the hose line. A second hose line 156 is connected at one end to the first outlet of the splitting manifold and at its second end to a mouthpiece worn 158 by the user requiring breathable air (i.e. underwater user, etc.). A third hose line 161 is connect at one to the second outlet of the splitting manifold and at its second is secured to second end 96 of second end cap 90, as described above.

Virtually at the moment air is added to the hose lines by compressor 150, air pressure is built up within the second hose line connected to the mouthpiece and also within the third hose line connected to second end cap 90. In view of passageway 102 of second end cap 90, the air pressure in the third hose line is permitted to push upon piston 80 (i.e. input to piston 80) which will provide sufficient force (i.e. enough to overcome the natural repelling force between magnets 60 and 70) to allow piston 80 to move magnet 70 closer to magnet 60. Thus, magnet 70 moves with the movement of piston 80. As will be described below, the movement and position of magnet 70 as read by the magnetic sensing element located in the cutout of cylinder 30 will determine whether to increase or decrease the speed of power propulsion 140, when pressure switch 105 is in closed position and controller 130 is “on”. A variation of the magnetic field caused by the movement of magnet 70, translates into a variation of voltage provided by controller 130. The variation in voltage from controller 130 determines whether power propulsion 140 will be driven with high rpm or low rpm.

In use, prior to the user breathing from mouthpiece, pressure in the hose lines is at a maximum, providing piston 80 with sufficient force to push or move magnet 70 closest to magnet 60. In one embodiment this pressure can be anywhere from about 50 psi to about 70 psi, and preferably about 55 psi. Pressure switch 105 is set such that when the set pressure reading (i.e. about 55 psi, etc.) is reached, pressure switch 105 opens to turn off controller 130, since air within the hose lines is at a maximum, thus, there is no need to run compressor assembly 150, since there is no need for additional air. As compressor assembly 150 is not running at all times during use, power consumption is conserved, allowing the air on demand breathing device to operate at a longer period of time.

As the user breathes through mouthpiece 158 air (or other gas or gas mixtures) is removed from within the hose lines, which causes the pressure to drop and once the pressure drops below the selected threshold (i.e. about 55 psi, etc.), pressure switch 105 closes causing controller to be turned “on”. The reduction of air pressure in the hose lines, also reduces the force being provided by piston 80 against magnet 70, thus permitting magnet 70 to move away from magnet 60 (in view of the repelling forces between the magnets). The sensing element senses this movement and sends a signal to controller 130 to increase the speed of power propulsion 140/compressor 150 to generate and release more air into the hose lines through outlet 152. The further apart magnet 70 is from magnet 60 correspondingly increases the speed of power propulsion 140/compressor 150. At a certain point, the air outputted into the hose lines from compressor 150, will cause the pressure (pounds per square inch—psi) in the hose lines to increase which causes piston 80 to create more force to move magnet 70 closer to magnet 60, which in turn reduces the speed of power propulsion 140/compressor 150. Also, once the increase in pressure within the hose lines exceeds the selected threshold (i.e. 55 psi, etc.), pressure switch 105 will open or (close), which turns off controller 130, and thus conserves the energy from battery pack 160, to permit it to last longer in duration in use. As the user draws air through the mouthpiece, the above process repeats itself as needed.

The transducer can work in a large range of pressure and is not limited to the above values, which are used for example purposes only and in connection with the graphic shown in FIG. 3 Other values can also be used and are considered within the scope of the invention.

Though two magnets are preferred for the movable member, other devices, including a magnet and spring, spring by itself, magnet and a compression spring, magnet and a pyrolytic graphite block or plate, hydraulic fluids, and/or other mechanisms which will provide an indication that more air should be produced by the compressor can be used and all are considered within the scope of the invention. Thus, the sensor can be made in multiple ways.

It should also be recognized that the system produces air, as needed, in a dynamic relationship with respect to the inhaling and exhaling of the users, the number of users associated with the system at one time, the underwater breathing experience of the user(s), the lung capacity of the user(s). All of these factors may play a part in the amount of air needed to be produced by the compressor in accordance with the operations of the present invention. Thus, the present invention sensor and system can also be considered as a dynamic sensor/system in addition to its variable characteristics; producing air in the most efficient way.

All measurements, amounts, values, sized, shapes, percentages, materials, configurations, securement mechanisms, sealing members, sensing members, orientations, etc. discussed above or shown in the drawing figures are merely by way of example and are not considered limiting and other measurements, amounts, values, sizes, shapes, percentages, materials, configurations, securement mechanisms, sealing members, sensing members, orientations etc. can be chosen and used and all are considered within the scope of the invention.

Unless feature(s) or characteristic(s) described in the specification or shown in the drawings for a claim element or claim term specifically appear in the claim with the claim element or claim term, then the inventor does not considered such feature(s) or characteristic(s) to be included for the claim element or claim term in the claim when and if the claim element or claim term is interpreted or construed.

While the invention has been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. A dynamic transducer for controlling an object, comprising:
a housing having a first end and a second end and defining a passageway extending therethrough from said first end to said second end;
a first end cap secured to the first end of the housing, said first end cap having a first end disposed within said passageway when said end cap is secured to the first end of the housing;
a multiple-part movable member at least partially disposed within the passageway;
a second end cap secured to the second end of the housing, said second end cap having an outer end adapted for attachment of an object, said outer end having an opening to permit communication between an attached object and the passageway of said housing; and
means for detecting movement of at least one part of the movable member caused by internal communication between the attached object and the passageway of said housing, wherein said means for sensing controlling another object based on the sensed movement.

2. The dynamic transducer of claim 1 wherein said multiple-part movable member comprises:
a first magnet having a first polarity on a first side and an opposite second polarity on a second side, said first magnet disposed within said passageway, said first side of said first magnet abutting the first end of said first end cap;
a second magnet having the first polarity on a first side and the opposite second polarity on a second side, said second magnet disposed within said passageway next to said first magnet such that the polarity of the first magnet on the side of the first magnet closest to the second magnet is opposite to the polarity of the side of the second magnet closest to the first magnet such that the first magnet and second magnet naturally repel each other within the passageway; and
a piston at least partially disposed within the passageway, said piston having a contact portion in contact with the side of the second magnet farthest from the first magnet;
wherein where maximum pressure is obtained within the object secured to the second end cap such maximum pressure causes said piston to move the second magnet closest to said first magnet within the passageway and wherein upon a pressure drop within the object secured to the second end cap less force is applied by the piston on the second magnet causing the second magnet to move away from the first magnet within the passageway, wherein the moving away of said second magnet is detected by said means for detecting which causes said means for detecting to send a signal to an object it is controlling.

3. The dynamic transducer of claim 1 wherein said means for detecting is a magnetic sensing element disposed within a cutout in said housing.

4. The dynamic transducer of claim 1 wherein said housing is a cylinder.

5. The dynamic transducer of claim 1 further comprising a sealing member disposed around a portion of said piston.

6. The dynamic transducer of claim 1 wherein said first end cap is adjustably secured to said housing such that how far the first end of said first end cap extends into said passageway can be adjusted.

7. A dynamic transducer for controlling an object, comprising:
a cylinder having a first end and a second end and defining a passageway extending therethrough from said first end to said second end;
a first end cap secured to the first end of the cylinder, said first end cap having a first end disposed within said passageway when said end cap is secured to the first end of the cylinder;
a first magnet having a first polarity on a first side and an opposite second polarity on a second side, said first magnet disposed within said passageway, said first side of said first magnet abutting the first end of said first end cap which acts as stop member for positioning said first magnet;
a second magnet having the first polarity on a first side and the opposite second polarity on a second side, said second magnet disposed within said passageway next to said first magnet such that the polarity of the first magnet on the side of the first magnet closest to the second magnet is opposite to the polarity of the side of the second magnet closest to the first magnet such that the first magnet and second magnet naturally repel each other within the passageway; and
a piston comprised of a base and a rod portion extending outward from the base, said rod portion at least partially disposed within the passageway and contacting the side of the second magnet farthest from the first magnet;
a second end cap secured to the second end of the cylinder, said second end cap having an outer end adapted for attachment to an air hose, said outer end having an opening to permit communication between an attached air hose and the passageway of said cylinder, the base of said piston enclosed within said second end cap when said second end cap is secured to the cylinder; and
a magnetic sensing element disposed within a cutout created along a portion of said cylinder adjacent to the location of the first magnet and said second magnet, said magnetic sensing element adapted for electrical communication with an object to be controlled;
wherein where maximum pressure is obtained within the air hose secured to the second end cap such maximum pressure causes said piston to move the second magnet closest to said first magnet within the passageway and wherein upon a pressure drop within the air hose secured to the second end cap less force is applied by the piston on the second magnet causing the second magnet to move away from the first magnet within the passageway, wherein the moving away of said second magnet is detected by said magnetic sensing element causing said magnet sensing element to send a signal to an object it is controlling.

8. The dynamic transducer of claim 7 further comprising a sealing member disposed around a portion of the base of said piston.

9. The dynamic transducer of claim 8 wherein said sealing member is an o-ring.

10. The dynamic transducer of claim 7 wherein said first end cap is adjustably secured to said cylinder such that how far the first end of said first end cap extends into said passageway can be adjusted.

11. The dynamic transducer of claim 7 wherein said first end cap is secured to said cylinder by a threaded connection and said second end cap is secured to said cylinder by a threaded connection.

12. The dynamic transducer of claim 7 wherein the object that is controlled by the signal sent by the magnetic sensing element is a controller member in communication with a power propulsion member of a compressor assembly, said power propulsion operating at a speed, wherein the signal received from the magnetic sensing element determines whether to increase or decrease the speed of said power propulsion.

13. The dynamic transducer of claim 12 further comprising a pressure switch in communication with the air hose wherein upon pressure within said air hose reaching a threshold level said pressure switch sends a signal to said controller to turn “off” causing the compressor assembly to be “off” and wherein the pressure within said air hose drops below the threshold level said pressure switch sends a signal to said controller to turn “on” causing the compressor assembly to turn “on”.

14. The dynamic transducer of claim 13 wherein said threshold level is any value falling within the range of about 50 psi to about 70 psi.

15. A dynamic transducer for controlling an object, comprising:
a cylinder having a first end and a second end and defining a passageway extending therethrough from said first end to said second end;
a first end cap threadably secured to the first end of the cylinder, said first end cap having a first end disposed within said passageway when said end cap is secured to the first end of the cylinder, wherein the threaded connection of said first end cap to said cylinder allows for adjustment of how far the first end of said first end cap extends into said passageway;
a first magnet having a first polarity on a first side and an opposite second polarity on a second side, said first magnet disposed within said passageway, said first side of said first magnet abutting the first end of said first end cap which acts as stop member for positioning said first magnet in a fixed position;
a second magnet having the first polarity on a first side and the opposite second polarity on a second side, said second magnet disposed within said passageway next to said first magnet such that the polarity of the first magnet on the side of the first magnet closest to the second magnet is opposite to the polarity of the side of the second magnet closest to the first magnet such that the first magnet and second magnet naturally repel each other within the passageway; and
a piston comprised of a base and a rod portion extending outward from the base, said rod portion at least partially disposed within the passageway and contacting the side of the second magnet farthest from the first magnet;
a second end cap threadably secured to the second end of the cylinder, said second end cap having an outer end adapted for attachment to an air hose, said outer end having an opening to permit communication between an attached air hose and the passageway of said cylinder, the base of said piston enclosed within said second end cap when said second end cap is secured to the cylinder; and
a sealing member disposed around a portion of the base of said piston;
a magnetic sensing element disposed within a cutout created along a portion of said cylinder adjacent to the location of the first magnet and said second magnet, said magnetic sensing element adapted for electrical communication with an object to be controlled;
wherein where maximum pressure is obtained within the air hose secured to the second end cap such maximum pressure causes said piston to move the second magnet closest to said first magnet within the passageway and wherein upon a pressure drop within the air hose secured to the second end cap less force is applied by the piston on the second magnet causing the second magnet to move away from the first magnet within the passageway, wherein the moving away of said second magnet is detected by said magnetic sensing element causing said magnet sensing element to send a signal to an object it is controlling.

16. The dynamic transducer of claim 15 wherein said sealing member is an o-ring.

17. The dynamic transducer of claim 15 wherein the air hose is in communication with a user's mouthpiece and as the user breathes in air from the air hose through the mouthpiece the air pressure within the air hose drops causing the second magnet to move farther away from the fixed location of the first magnet.

18. The dynamic transducer of claim 17 wherein the object that is controlled by the signal sent by the magnetic sensing element is a controller member in communication with a power propulsion member of a compressor assembly, said power propulsion operating at a speed, wherein the signal received from the magnetic sensing element determines whether to increase or decrease the speed of said power propulsion depending on the position of the second magnet with respect to the fixed position of the first position.

19. The dynamic transducer of claim 18 further comprising a pressure switch in communication with the air hose wherein upon pressure within said air hose reaching a threshold level said pressure switch sends a signal to said controller to turn “off” causing the compressor assembly to be “off” and wherein the pressure within said air hose drops below the threshold level said pressure switch sends a signal to said controller to turn “on” causing the compressor assembly to turn “on”.

20. The dynamic transducer of claim 19 wherein said threshold level is any value falling within the range of about 50 psi to about 70 psi.
